(19) United States
(12) Patent Application Publication
(10) Pub. No.: US 2011/0204062 A1
(43) Pub. Date: Aug. 25, 2011

(54) PRESSURE VESSEL

(76) Inventors: Michael Christy, Houghton Cambridgeshire (GB); Phillip Wallis, Lincolnshire (GB)

(21) Appl. No.: 13/060,008

(22) PCT Filed: Aug. 7, 2009
(86) PCT No.: PCT/GB2009/050994

§ 371 Date: May 10, 2011

(30) Foreign Application Priority Data
Aug. 20, 2008 (GB) 0815189.6

(51) Int. Cl. F17C 1/00; B65D 8/00

(52) U.S. Cl. 220/581; 220/4.05

(57) ABSTRACT

A pressure vessel 10 comprises a container 13 for storing contents under pressure, a head section 11 and a base section 12. The head section 11 and base section 12 locate on opposing ends of the container 13 and each have projecting fingers 22, preferably five, which engage around the container 13. A retaining ring 14 locates around the container 13 and holds the fingers 22 in place. The head section 11, base section 12 and ring 14 all serve to resist expansion of the container 13. The pressure vessel may serve to store beverages such as beer.

The present invention relates to a pressure vessel and in particular a pressure vessel for the storage and/or transport of pressurised contents.

Certain products are stored and transported in containers such as barrels and kegs, under raised pressure. This is done for a variety of reasons, including maintaining the characteristics of the product, increasing the quantity of product that fits in a certain volume and aiding in the delivery of the product from that storage vessel. One particular instance of particular interest to the present invention relates to drinks such as beers which are stored and transported to their point of sale in pressurised barrels or kegs and then dispensed directly from these. Currently used pressure vessels, such as kegs, are formed of metals such as steel or aluminium, which provide sufficient strength to resist the expansive force of the pressurised contents as well as being able to withstand the rough handling associated with the transport of these items. Historically such barrels were constructed from wood, but nowadays commercial operations use metal barrels (or kegs). Such existing barrels are both expensive to produce, heavy to handle even when empty, and impractical to repair—as they are a one piece construction which must be totally replaced if any part thereof becomes damaged.

The present invention aims to overcome some or all of these problems by constructing a pressure vessel from several separate components, each of which is formed from a lightweight material but which together co-operate to provide sufficient strength to resist the pressurised contents and rough handling.

Whilst the present invention provides a new design of pressure vessel suitable for the storage and transport of a wide variety of products and substances, it will primarily be discussed in the context of beverage (and particularly beer) handling. It is however not limited to such liquids, nor indeed to liquids alone. It could be used for any substance in any form that required pressurisation.

According to the present invention there is provided a pressure vessel comprising:
a container to hold the contents to be stored under pressure, said container having opposed ends;
a head that locates on one end of the container and has at least one downwardly projecting finger;
a base that locates on the opposed end and has at least one upwardly projecting finger, the downwardly and upwardly projecting fingers of the head and base engaging around the container; and
a retaining ring which locates around the container and fingers and holds the fingers in place, the head, base and ring together resisting expansion of the container.

In creating the present invention the aim was to develop a pressure vessel that could be constructed from plastics material rather than the conventional metal. The present invention does permit construction from plastic and it is therefore highly preferred that one or more of the components are manufactured predominantly, substantially or wholly from one or more of a variety of plastics materials. Clearly equivalent material providing similar properties may also be utilised. The various components of the pressure vessel need not be constructed from the same material as each other. Each may be constructed from a type of material providing the optimum characteristics for its particular function. For example, the base, head and retaining ring may be formed from a higher strength material as compared to the container. The container's main function is to hold the material, usually a liquid, for storage and transport, and must not adversely affect that material for example by tainting its contents or permitting excessive permeation between those contents and the atmosphere. Clearly such characteristics would not apply to the head, base and ring, which do not come into contact with the contents, but instead these parts must function to restrain any expansion of the container caused by the pressure of the contents, and to provide mechanical strength for handling.

It is possible for the head and base to have only one finger each, with each finger extending up to halfway circumferentially around the container. However, it is advantageous that the head and base each has a plurality of fingers and it has been found that at least three fingers on each is convenient with five being particularly good. It is preferred that the fingers of the head and base mesh to form an inter-fitting relationship around the sides of the container. Such an inter-fitting relationship could cover some or all of the sides of the container. Depending on the strength of the container some gaps between the fingers can be left.

The container is preferably generally cylindrical or barrel shaped with flattened ends and a curved side wall—although certain other shapes could also be employed. The container usually has an axis (of rotational symmetry) extending through the centre of each end.

One or more of the base and head may be provided with a handling ring that extends generally axially away from the end of the container on which the head or base are located. This handling ring may be further provided with openings to form hand-holds. Such handling rings on the top and bottom of the vessel assist in its handling in a variety of ways. Kegs are frequently manoeuvred by hand and the handling rings in the present invention aid not only lifting and stacking of the barrels but also their movement. The assembled vessel may be grasped by the handling ring on the head and inclined such that it may be rolled on the handling ring on the base. The head and the base are preferably adapted to assist in the stacking of several such pressure vessels one on top of the other. The base handling ring may provide a stable stand on which the vessel may be stood, either on a flat surface or the upper handling ring of another vessel.

The head and base may be substantially the same in construction, with the possible exception of arrangements that assist in stacking. Consequently, features described in respect of one may in general apply equally to the other. The head and the base are preferably substantially the same in shape and configuration as this simplifies manufacture and allows them to function interchangeably.

The head, and/or base, may comprise a generally circular shoulder from which the fingers extend axially. Such axial extension is generally parallel to the axis of the container. If present a handling ring may extend in an opposite axial direction from an opposite side of the shoulder. The handling ring may also be formed from a shaped continuation of the shoulder. The handling ring will preferably be of a reduced diameter with respect to the shoulder. Except insofar as bung hole access is required, the base and head may form a complete cover to the ends of the container. However, it may be appropriate for at least a portion of the area overlying the ends (such as that within the handling rings) to be open.

The fingers may take a variety of shapes and may all be different. However, it is highly advantageous that all fingers are essentially equivalent. Preferably each finger is generally trapezoid in shape tapering towards the outer end. Preferably the fingers are shaped such that the gap between two adjacent fingers on the base exactly matches the shape of the fingers extending from the head—and vice versa.

The retaining ring is preferably generally tubular. The diameter of the retaining ring is preferably such that it may snugly engage over the fingers. The width of the retaining ring (ie the height of the cylinder) is preferably approximately equal to the length of the fingers.

Preferably the outer end of each finger is provided with a ridge on its radially outer surface. When the components are assembled the retaining ring sits snugly between the ridges on the fingers of the base section (which ridges bear on one circular edge of the retaining ring) and the ridges of the fingers extending from the head section (which ridges bear on the opposite circular surface of the retaining ring). In this way the retaining ring prevents both radial expansion of the container as well as axial extension. For axial extension to occur the head and base section would need to move apart, however the retaining ring prevents that axial separation due to the engagement of the ridges with the retaining ring.

The container may be provided with one or more suitable opening. Said one or more suitable opening, or bung hole, may be located in an end of the container. Preferably the head and/or base section do not cover at least that portion of the respective end walls. The nature and quantity of such openings depends on the nature of the contents stored therein.

Barrels and kegs are frequently transported by rolling them on their circumferential surfaces. Preferably, therefore, the retaining ring, which is often of the greatest diameter, is provided with at least one, but preferably two or more, circumferentially extending rolling ridges upon which the pressure vessel may be rolled.

To assemble the pressure vessel of the present invention, the components must be fitted together. One convenient way of achieving this is to locate the container into the base and then to engage the head on the opposite end of the container so that the fingers of the head and base inter-fit. The retaining ring may then be passed vertically downwards over the head section until it engages around the fingers. If, as is desirable, the fingers are provided with ridges, the retaining ring must pass over the ridges of the fingers extending upwardly from the base. Whilst the construction of the fingers should permit a sufficient degree of flexing for the fingers to move inwards so that the ridges pass beneath the retaining ring before flexing outwards to engage behind it, a snug fit between the container, base and head might prevent this. Therefore, whilst a snug fit is desirable in all other parts to prevent expansion of the container before it engages the head, base and ring, a small groove may be formed in the side wall to permit a sufficient degree of inward radial deformation of one set of fingers as the retaining ring passes thereover.

Clearly, if the components of the barrel are to be disassembled, for example for cleaning or repair, the ridges on the fingers may be depressed into the groove and then the retaining ring lifted and axially slid off the assembly.

In order that it may be better understood, but by way of example only, three embodiments of the present invention will now be described in more details with reference to the accompanying drawings in which:

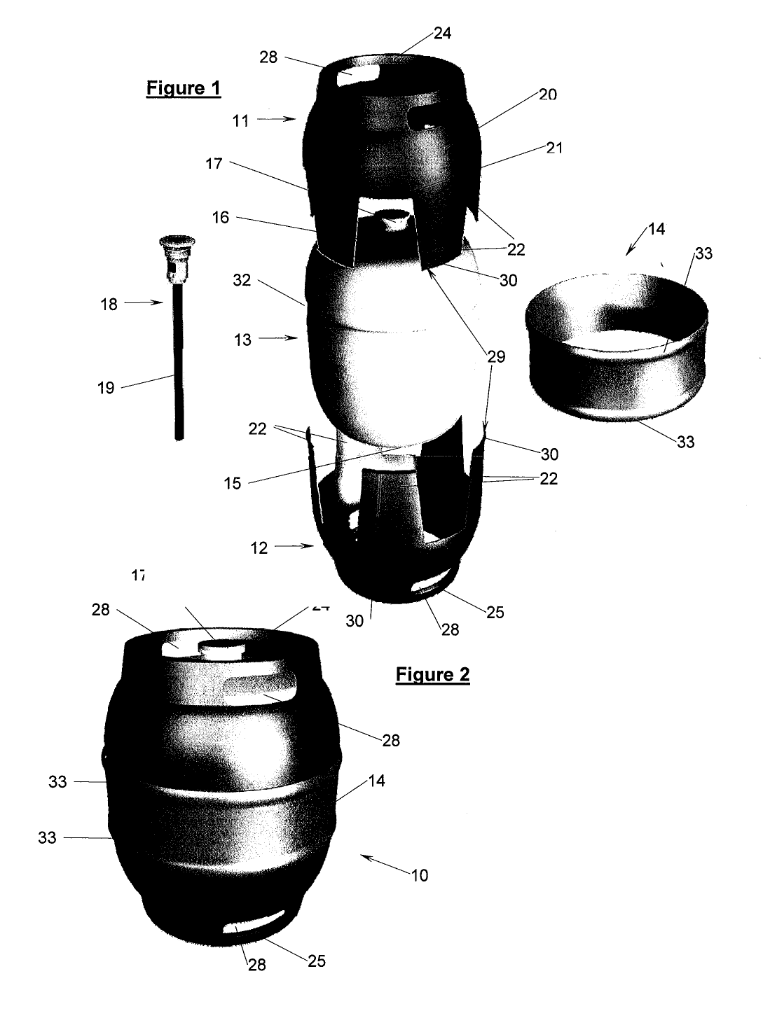

FIG. 1 is an exploded perspective view of the various components of one embodiment of the present invention;

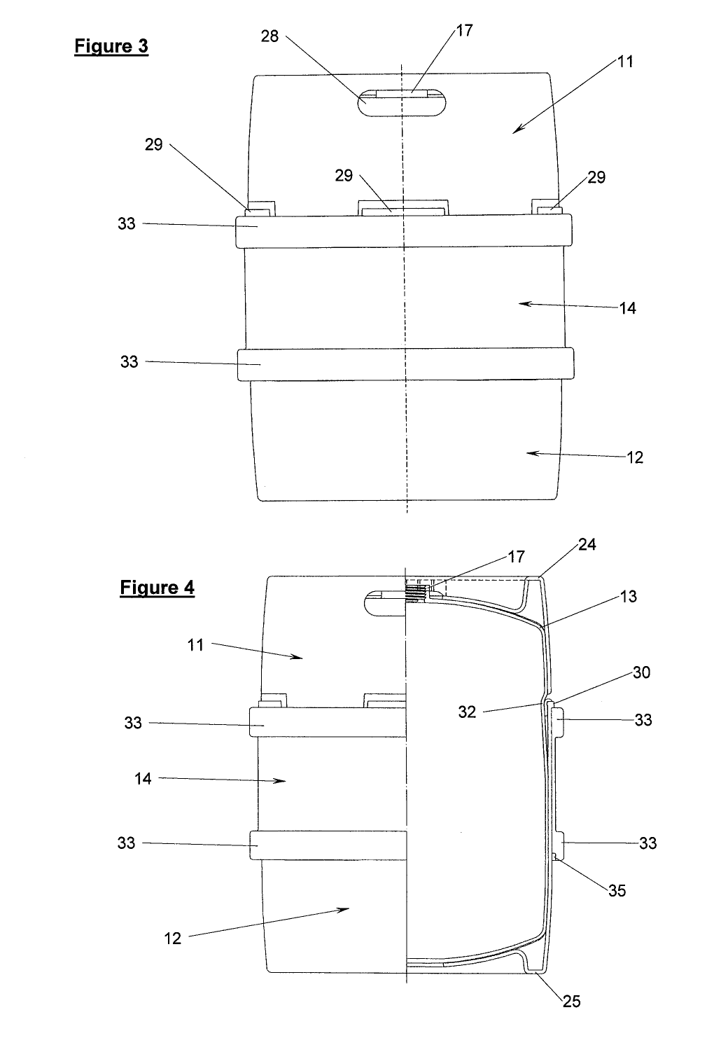

FIG. 2 is a perspective view from the side of those components assembled to form a first embodiment of pressure vessel;

FIG. 3 is a side view of a slightly different shaped second embodiment of pressure vessel;

FIG. 4 is a partial vertical section through the second embodiment of pressure vessel; and

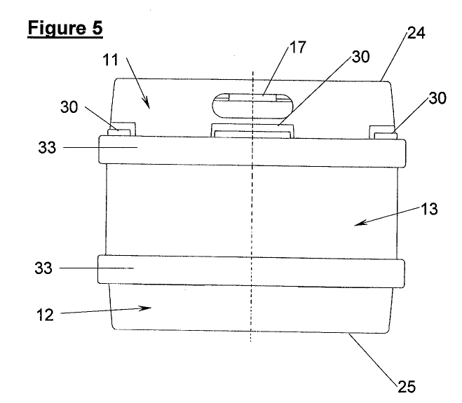

FIG. 5 is a side view of a lower volume third embodiment of pressure vessel.

Referring to FIGS. 1 and 2 there is shown a first embodiment of pressure vessel generally indicated 10 which is assembled from a head 11, a base 12, a container 13 and a retaining ring 14. The container 13 is generally cylindrical with an upper end 16 provided with a bung hole 17 and a lower end 15. A filling and emptying mechanism 18 for the contents is shown and the long pipe shaft 19 extends downwards into the interior of the container 13 to reach the bottom.

The head 11 and base 12 each comprise a generally circular curved shoulder region 20. From the inner edge 21 of each shoulder region 20 a plurality of fingers 22 extend axially with respect to the container 13. Each of the head and base are substantially similar and each has five fingers 22.

The internal profiles of the head and base correspond to the profile of the container 13 around which they will closely locate. As the container 13 is generally circular the profiles of the head and base 11 and 12 are also generally circular.

At the outer end (i.e. the end opposite the fingers) of the head 11 there is provided an upper handling ring 24. On the base 12 an equivalent base handling ring 25 is also provided. Handholds 28 are provided through the handling rings 24, 25 to aid manual and mechanical grasping.

The fingers 21 are in this embodiment are generally trapezoid in shape tapering to their free ends 29 and the shape of the fingers of the head correspond to the gaps between the fingers of the base and vice versa. This allows the fingers to closely inter-fit when the head and base are brought together.

The retaining ring 14 is generally circular and has a width slightly less than the length of the fingers 22. The retaining ring 14 is provided with continuous, circumferentially extending, rolling ridges. These thickened areas provide convenient surfaces upon which the assembled vessel may be rolled.

To assemble the pressure vessel, which in this instance is a beer barrel, the container 13 is located into the base 12 such that the lower end 15 of the container engages the internal surface of the base—with the curve of the container's shoulder (i.e. the area of transition between the side wall and the end wall) engaging the inside of the curved shoulder region of the base. The fingers 22 will at this point be extending upwards over the side of the container 13. The free ends 29 of each finger are provided with a ridge 30 which aligns with a circumferential groove 32 formed around the side of the container. The ridges 30 usually extend circumferentially.

The head 11 is then located over the upper end 16 of the container 13 so that the curved shoulder region 20 of the head rests upon the curved transition region between the upper end 16 of the container and the side thereof. At this point the fingers 22 depending from the head 11 will locate in the spaces between the fingers 22 of the base 12. The retaining ring 13 may then be slid axially over the assembly until it is in position overlying the inter-fitted fingers 22. The retaining ring would prevent the unintentional axial separation of the head and base as well as any radial expansion of the container 13 and fingers 22.

An assembled vessel 10 is shown in FIG. 2. This vessel may have pressurised contents introduced via means 18, which may then be sealed to store the contents under pressure and allow their transportation. The pressure within the container 13 would cause some expansion, but the component parts, which are constructed from plastics material, resist all but a small degree of expansion. This small expansion would only tend more tightly to engage the retaining ring, head and base.

As assembled this pressure vessel 10 permits handling in a way equivalent to existing kegs. For example, the vessel may be rolled on the handling rings 24, 25 or the circumferential rolling ridges 33.

FIGS. 3 and 4 show a second embodiment of vessel which is fundamentally similar to that described with respect to FIGS. 1 and 2, and for which like parts will be given like reference numerals. The only significant distinction between this and the first embodiment is the shape, which is somewhat less curved in the upper region.

FIG. 4 shows a partial vertical cross-section in which the engagement of the retaining ring with the ridges 30 is more easily understood. As can be seen in FIG. 4, the free end 29 of the finger 22 that extends upward from the base 12 aligns with the circumferential groove 32. A ridge 30 is provided on that fee end and extends partially radially with respect to the container 13. During assembly the retaining ring 14 is slid axially from above (as viewed in FIG. 4) over the head 11. When the retaining ring reaches the ridge 30 the finger 22 is resiliently deformed inwardly sufficient for the retaining ring to pass thereover. This deformation is accommodated by the circumferential groove 32. Once the retaining ring 14 has passed to the correct position the finger 22 will flex back so that the ridges 30 locate behind the retaining ring and prevent its vertical removal—unless those fingers are again flexed deliberately inwards. At this point the corresponding ridges 30 formed on the free ends 29 of the fingers 22 depending from the head 11 (which are not visible in FIG. 3 or 4) will locate against a lower end of the retaining ring or in an appropriately shaped annular groove 35 as can be seen in FIG. 4. This prevents further downward axial movement of the retaining ring 14.

In the embodiment in FIGS. 3 and 4, and indeed the third embodiment shown in FIG. 5, the rolling ridges 33 are somewhat wider than those shown in respect of the first embodiment in FIGS. 1 and 2. The embodiment in FIG. 5 is similar to that shown in FIGS. 3 and 4, however the container has a lower volume and the shoulder region of the head and base are shortened such that a smaller vessel is formed.

The present invention provides a pressure vessel, particularly a beverage barrel or keg that may be constructed from lightweight material such as plastics, which may be easily formed by techniques such a blow moulding and injection moulding, yet which also provides a vessel that is strong and sturdy enough to be pressurised and handled in a similar fashion to existing metal pressure vessels.

1. A pressure vessel comprising:
a container to hold the contents to be stored under pressure, said container having opposed ends;
a head located on one end of the container and has at least one downwardly projecting finger;
a base located on the opposed end and has at least one upwardly projecting finger, the downwardly and upwardly projecting fingers of the head and base engaging around the container; and
a retaining ring located around the container and fingers and holds the fingers in place, the head, the base and the ring together resisting expansion of the container.

2. The pressure vessel as claimed in claim 1, in which the head and base each have a plurality of fingers.

3. The pressure vessel as claimed in claim 2, in which the head and base each have at least 3 similar fingers.

4. The pressure vessel as claimed in claim 1, in which the fingers of the head and base inter-fit around the container.

5. The pressure vessel as claimed in claim 1, in which at least one of the head, the base, the retaining ring and the container are made from plastics material.

6. The pressure vessel as claimed in claim 1, in which at least one of the head and the base are provided with a handling ring.

7. The pressure vessel as claimed in claim 6, in which at least one hand-hold is formed on at least one handling ring to aid manual handling.

8. The pressure vessel as claimed in claim 6, in which the base handling ring provides a stand on which the vessel may be stood.

9. The pressure vessel as claimed in claim 1, in which at least one of the head and the base each have a circular shoulder from which the at least one finger axially extends.

10. The pressure vessel as claimed in claim 1, in which ridges are provided on an external face of each finger, which ridges engage with the ring to prevent axial displacement of the base or head.

11. The pressure vessel as claimed in claim 1, in which the head and base are substantially the same.

12. The pressure vessel as claimed in claim 1, in which an opening for filling or emptying the container is provided on one end thereof.

13. The pressure vessel as claimed in claim 1, in which the retaining ring has circumferential rolling ridges on which the vessel may be rolled.

14. The pressure vessel as claimed in claim 1, in which a groove is formed in the side of the container to permit resilient inward radial deformation of one set of fingers during assembly of the vessel.

15. The pressure vessel as claimed in claim 1, which is a barrel or beverage keg.

16. The pressure vessel as claimed in claim 2, in which the head and the base each have at least 5 similar fingers.
